(19) United States
(12) Patent Application Publication
(10) Pub. No.: US 2026/0187384 A1
(43) Pub. Date: Jul. 2, 2026

(54) TRANSLATION LANGUAGE EVALUATION APPARATUS, TRANSLATION LANGUAGE EVALUATION SYSTEM, TRANSLATION LANGUAGE EVALUATION METHOD, AND PROGRAM

(71) Applicants: Sony Interactive Entertainment Inc., Tokyo (JP); Sony Group Corporation, Tokyo (JP)

(72) Inventors: Shinpei Kameoka, Kanagawa (JP); Norihiro Nagai, Kanagawa (JP); Takao Okuda, Tokyo (JP); Satoshi Asakawa, Tokyo (JP)

(21) Appl. No.: 19/547,465

(22) Filed: Feb. 23, 2026

Related U.S. Application Data
(63) Continuation of application No. PCT/JP2023/030907, filed on Aug. 28, 2023.

(51) Int. Cl. G06F 40/51; G06T 7/20; G06T 7/50; G10L 15/02

(52) U.S. Cl. CPC G06F 40/51; G06T 7/20; G06T 7/50; G10L 15/02; G06T 2207/30201; G10L 2015/025

(57) ABSTRACT

Whether or not a translated text corresponds to the character's mouth movements is appropriately evaluated. At least one processor (11) generates a similarity degree indicating a similarity of the character's mouth movements, based on the character's mouth shape corresponding to each of phonemes (33a through 33c) included in a pre-translation phoneme sequence (33) and on the character's mouth shape corresponding to each of phonemes (34a through 34e, 35a, and 35b) included in post-translation phoneme sequences (34 and 35).

### CROSS-REFERENCE TO RELATED APPLICATIONS

This application is a Continuation of International Application No. PCT/JP2023/030907, having an International Filing Date of Aug. 28, 2023. This disclosure of the prior application is considered part of the disclosure of this application.

### FIELD

The present disclosure relates to a translation language evaluation apparatus, a translation language evaluation system, a translation language evaluation method, and a program.

### BACKGROUND

There are cases where audio of a character appearing in content such as games and video works and speaking a text in a given language is replaced with (dubbed in) the audio of another language (referred to as the translation language hereunder where appropriate).

### SUMMARY

In a case where the character's mouth shape corresponding to a translated text that is a translation of a pre-translation source text differs significantly from the character's mouth shape corresponding to the source text, the audio of the translated text will not correspond to the character's mouth movements. This sometimes causes game players and viewers of video works to experience a sense of discomfort.

An object of the present disclosure is therefore to appropriately evaluate whether or not the translated text corresponds to the character's mouth movements.

### Solution to Problem

A translation language evaluation apparatus according to the present disclosure may include at least one processor. The at least one processor may acquire a pre-translation phoneme sequence indicating an order of pre-translation phonemes on the basis of a pre-translation source text. On the basis of a translated text that is a translation of a language of the pre-translation source text into another language, the at least one processor may acquire a post-translation phoneme sequence indicating an order of post-translation phonemes. On the basis of a mouth shape of a character corresponding to each of the pre-translation phonemes included in the pre-translation phoneme sequence and a mouth shape of the character corresponding to each of the post-translation phonemes included in the post-translation phoneme sequence, the at least one processor may generate a similarity degree indicating the similarity of mouth movements of the character. This apparatus makes it possible to appropriately evaluate whether or not the translated text corresponds to the character's mouth movements.

A translation language evaluation system according to the present disclosure may include at least one processor. The at least one processor may acquire a pre-translation phoneme sequence indicating the order of pre-translation phonemes on the basis of a pre-translation source text. On the basis of a translated text that is a translation of a language of the pre-translation source text into another language, the at least one processor may acquire a post-translation phoneme sequence indicating an order of post-translation phonemes. On the basis of a mouth shape of a character corresponding to each of the pre-translation phonemes included in the pre-translation phoneme sequence and a mouth shape of the character corresponding to each of the post-translation phonemes included in the post-translation phoneme sequence, the at least one processor may generate a similarity degree indicating the similarity of mouth movements of the character. This system makes it possible to appropriately evaluate whether or not the translated text corresponds to the character's mouth movements.

A translation language evaluation method according to the present disclosure may include a step of acquiring a pre-translation phoneme sequence indicating the order of pre-translation phonemes on the basis of a pre-translation source text, on the basis of a translated text that is a translation of a language of the pre-translation source text into another language, a step of acquiring a post-translation phoneme sequence indicating an order of post-translation phonemes, and, on the basis of a mouth shape of a character corresponding to each of the pre-translation phonemes included in the pre-translation phoneme sequence and a mouth shape of the character corresponding to each of the post-translation phonemes included in the post-translation phoneme sequence, a step of generating a similarity degree indicating the similarity of mouth movements of the character. This method makes it possible to appropriately evaluate whether or not the translated text corresponds to the character's mouth movements.

A program according to the present disclosure may cause a computer to perform a procedure of acquiring a pre-translation phoneme sequence indicating the order of pre-translation phonemes on the basis of a pre-translation source text, on the basis of a translated text that is a translation of a language of the pre-translation source text into another language, a procedure of acquiring a post-translation phoneme sequence indicating an order of post-translation phonemes, and, on the basis of a mouth shape of a character corresponding to each of the pre-translation phonemes included in the pre-translation phoneme sequence and a mouth shape of the character corresponding to each of the post-translation phonemes included in the post-translation phoneme sequence, a procedure of generating a similarity degree indicating the similarity of mouth movements of the character. This program using a computer makes it possible to appropriately evaluate whether or not the translated text corresponds to the character's mouth movements.

### BRIEF DESCRIPTION OF THE DRAWINGS

FIG. 1 is a view depicting an exemplary hardware configuration for a translation language evaluation method as an example of embodying the present disclosure.

FIG. 2 is a functional block diagram depicting exemplary functions implemented by the translation language evaluation method.

FIG. 3 is a set of views depicting a source text, translated texts, a pre-translation phoneme sequence, and post-translation phoneme sequences acquired or generated by the functions of a translation language evaluation apparatus.

FIG. 4 is a set of views depicting exemplary utterance durations of the phonemes included in the phoneme sequences.

FIG. 5A is another set of views depicting exemplary utterance durations of the phonemes included in the phoneme sequences.

FIG. 5B is another set of views depicting exemplary utterance durations of the phonemes included in the phoneme sequences.

FIG. 6 is a set of views depicting an exemplary method of generating similarity degrees.

FIG. 7 is a view depicting durations in which utterance durations in the example of FIG. 4 overlap with each other.

FIG. 8 is a flowchart depicting an exemplary flow of processing performed by the translation language evaluation apparatus.

FIG. 9 is a functional block diagram depicting other exemplary functions implemented by the translation language evaluation apparatus.

FIG. 10 is another set of views depicting exemplary utterance durations of the phonemes included in the phoneme sequences.

### DETAILED DESCRIPTION

### 1. First Implementation

An implementation of the present disclosure is described below with reference to the accompanying drawings. A translation language evaluation apparatus embodying this disclosure is designed to appropriately evaluate whether a translated text that is a translation of a pre-translation source text corresponds to the mouth movements of a character speaking the source text (whether or not audio of the character when speaking the translated text corresponds to the mouth movements of the character when speaking the source text), on the basis of the mouth shape of the character when speaking the source text and the mouth shape of the character when speaking the translated text that is the translation of the source text.

### 1-1. Hardware Configuration

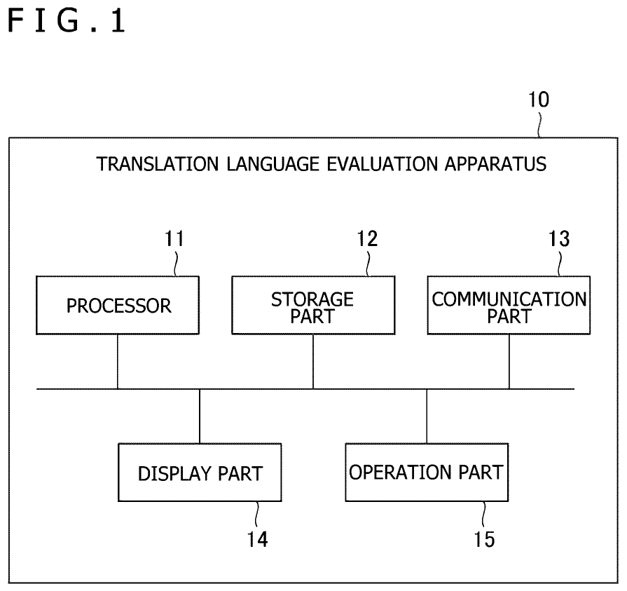

FIG. 1 is a view depicting an exemplary hardware configuration of a translation language evaluation apparatus 10 (translation language evaluation system). For example, the translation language evaluation apparatus 10 may be a computer such as a personal computer which, as depicted in FIG. 1, may include a processor 11, a storage part 12, a communication part 13, a display part 14, and an operation part 15.

For example, the processor 11 is a program-controlled device such as a CPU (Central Processing Unit) operating according to programs installed in the translation language evaluation apparatus 10. The storage part 12 is a storage medium such as a ROM (Read Only Memory), a RAM (Random Access Memory), an SSD (Solid State Drive), or an HDD (Hard Disk Drive). The storage part 12 stores data such as the programs executed by the processor 11. The communication part 13 is a communication interface such as a network board, for example. The display part 14 is a display device such as a liquid crystal display or an organic EL (Electro Luminescence) display displaying various images under instructions from the processor 11. The operation part 15 is a user interface such as a keyboard, a mouse, or a game controller receiving a user's operation input and outputting signals indicating the user's input to the processor 11.

In addition to the above, the translation language evaluation apparatus 10 may include an optical disk drive that reads optical disks, video output terminals such as DisplayPort (registered trademark), data input/output terminals such as a USB (Universal Serial Bus), speakers, and audio output terminals such as an earphone jack.

### 1-2. Functional Blocks

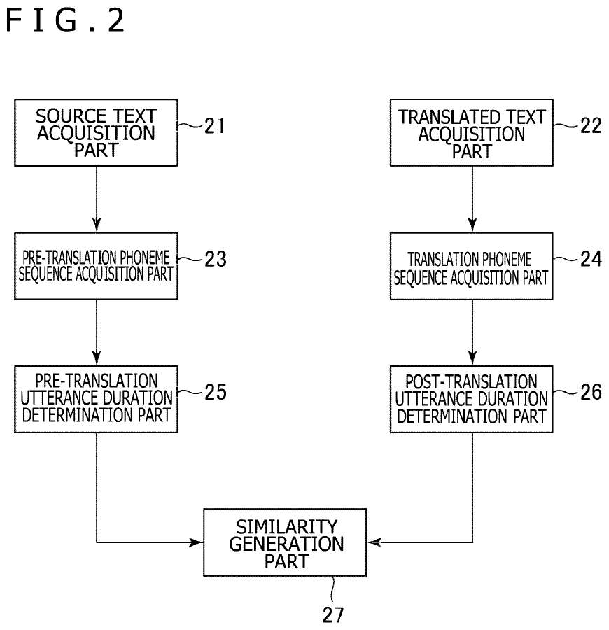

FIG. 2 is a functional block diagram depicting exemplary functions implemented by the translation language evaluation apparatus 10 (translation language evaluation system). As depicted in FIG. 2, the translation language evaluation apparatus 10 may functionally include a source text acquisition part 21, a translated text acquisition part 22, a pre-translation phoneme sequence acquisition part 23, a post-translation phoneme sequence acquisition part 24, a pre-translation utterance duration determination part 25, a post-translation utterance duration determination part 26, and a similarity generation part 27. These functions may be implemented mainly by the processor 11 or by multiple processors including the processor 11. It is to be noted that not all functions depicted in FIG. 2 need to be implemented by the translation language evaluation apparatus 10 and that functions other than those in FIG. 2 may also be implemented thereby.

### 1-2-1. Source Text Acquisition Part and Translated Text Acquisition Part

The source text acquisition part 21 acquires a pre-translation source text. The translated text acquisition part 22 acquires a text translated from the source text (e.g., source text in English) obtained by the source text acquisition part 21 into another language (e.g., Japanese). The source text acquisition part 21 may acquire text data as the source text. Similarly, the translated text acquisition part 22 may acquire text data as the translated text. Preferably, the translated text acquisition part 22 may acquire multiple translated text candidates as the translated text.

### 1-2-2. Pre-Translation Phoneme Sequence Acquisition Part and Post-Translation Phoneme Sequence Acquisition Part

On the basis of the pre-translation source text acquired by the source text acquisition part 21, the pre-translation phoneme sequence acquisition part 23 acquires a pre-translation phoneme sequence indicating the order of pre-translation phonemes. The post-translation phoneme sequence acquisition part 24 acquires the post-translation phoneme sequence indicating the order of post-translation phonemes, based on the translated text obtained by the translated text acquisition part 22.

The phonemes included in the phoneme sequences acquired by the pre-translation phoneme sequence acquisition part 23 and by the post-translation phoneme sequence acquisition part 24 may be information indicated, for example, by symbols such as international phonetic signs. Further, each of the phonemes in the phoneme sequences may be information indicating the mouth shape of the character corresponding to the phoneme in question (e.g., mouth image, and feature quantity of the mouth shape).

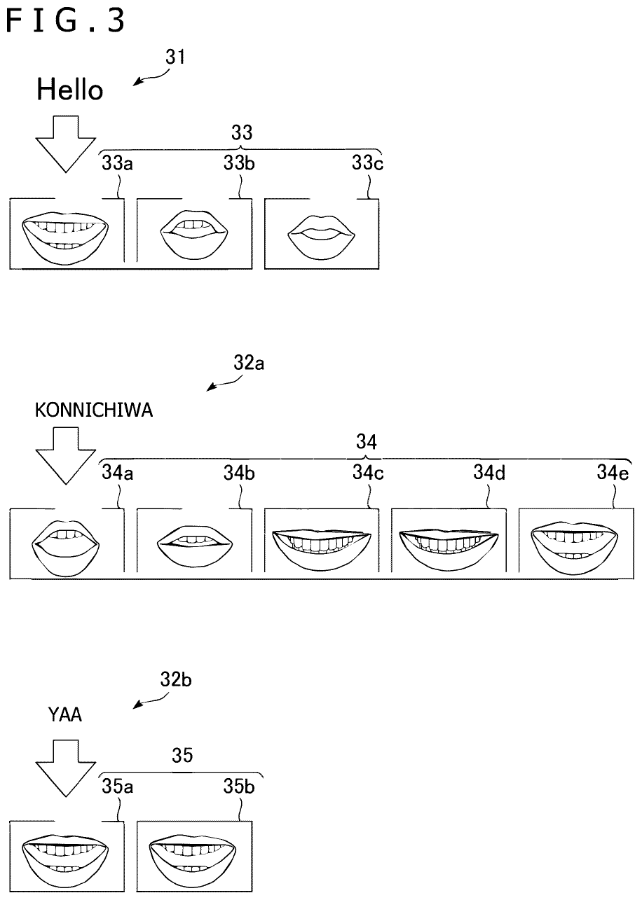

FIG. 3 is a set of views depicting a source text, translated texts, a pre-translation phoneme sequence, and post-translation phoneme sequences acquired or generated by the functions of the translation language evaluation apparatus 10. In the example of FIG. 3, the source text acquisition part 21 acquires a source text 31 “Hello” in English. Also in the example of FIG. 3, the translated text acquisition part 22 acquires a translated text 32a “Konnichiwa” and a translated text 32b “Yaa” as the texts translated from the source text 31 in English into Japanese.

Also in the example of FIG. 3, the pre-translation phoneme sequence acquisition part 23 acquires a pre-translation phoneme sequence 33 indicating the order of the phonemes in the source text 31. In the pre-translation phoneme sequence 33, three pre-translation phonemes 33a through 33c are lined up in that order. Also in the example of FIG. 3, the post-translation phoneme sequence acquisition part 24 acquires a post-translation phoneme sequence 34 indicating the order of the phonemes in the translated text 32a and a post-translation phoneme sequence 35 indicating the order of the phonemes in the translated text 32b. In the post-translation phoneme sequence 34, five post-translation phonemes 34a through 34e are lined up in that order. Further, in the post-translation phoneme sequence 35, two post-translation phonemes 35a and 35b are lined up in that order.

In the description that follows, the pre-translation phoneme sequence 33 and the post-translation phoneme sequences 34 and 35 may simply referred to as the phoneme sequences. Whereas FIG. 3 depicts the phonemes 33a through 33c, 34a through 34e, 35a, and 35b included in the phoneme sequences 33 through 35 in the form of mouth shapes, the information regarding the phonemes may alternatively be indicated by international phonetic signs. Also in FIG. 3, the phonemes 33a through 33c, 34a through 34e, 35a, and 35b may be different from one another. Of these phonemes, the phonemes 33a, 34e, 35a, and 35b, which do not coincide with each other, may be similar to one another. Likewise, the phonemes 34c and 34d may be similar to each other.

The pre-translation phoneme sequence acquisition part 23 may acquire the phoneme sequence 33 by generating phonemes (phonemes 33a through 33c) based on the source text 31. Alternatively, the pre-translation phoneme sequence acquisition part 23 may acquire, as the phoneme sequence 33 of the source text 31, the phoneme sequence stored in the storage part 12 or in an external storage device in association with the source text 31. Further, the pre-translation phoneme sequence acquisition part 23 may also acquire the phoneme sequence 33 by receiving phoneme sequence information via the communication part 13. Likewise, the post-translation phoneme sequence acquisition part 24 may acquire the phoneme sequences 34 and 35 by generating phonemes based on the translated texts 32a and 32b. The post-translation phoneme sequence acquisition part 24 may alternatively acquire, as the phoneme sequences 34 and 35, the phoneme sequences stored in association with the translated texts 32a and 32b.

### 1-2-3. Pre-Translation Utterance Duration Determination Part and Post-Translation Utterance Duration Determination Part

The pre-translation utterance duration determination part 25 determines the utterance durations of the pre-translation phonemes included in the pre-translation phoneme sequence acquired by the pre-translation phoneme sequence acquisition part 23. The post-translation utterance duration determination part 26 determines the utterance durations of the post-translation phonemes included in the post-translation phoneme sequences acquired by the post-translation phoneme sequence acquisition part 24.

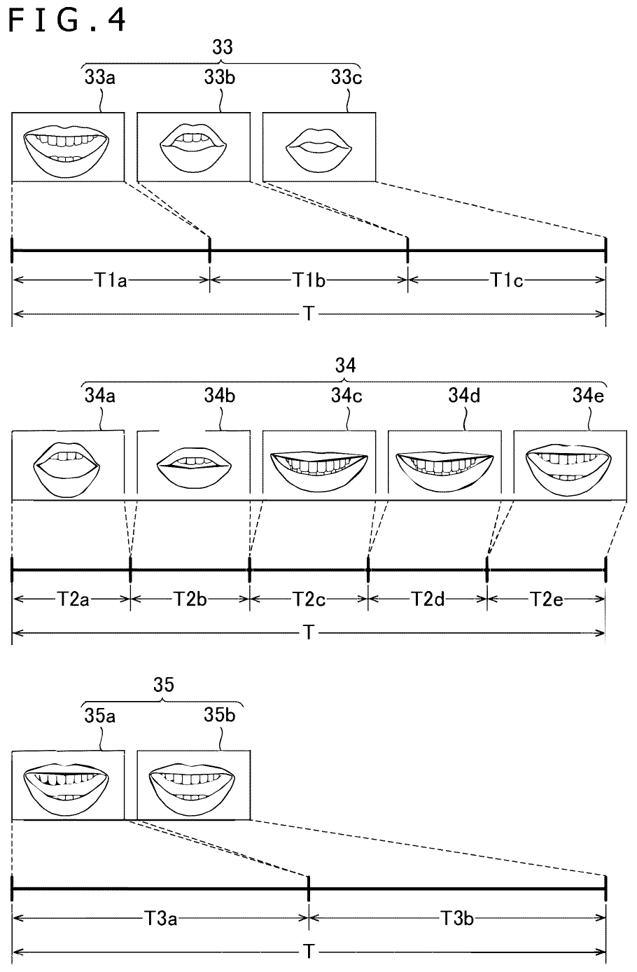

FIG. 4 is a set of views depicting exemplary utterance durations of the phonemes included in the phoneme sequences. In the example of FIG. 4, the pre-translation utterance duration determination part 25 determines utterance durations T1a through T1c corresponding to the phonemes 33a through 33c included in the pre-translation phoneme sequence 33. Also in the example of FIG. 4, the post-translation utterance duration determination part 26 determines utterance durations T2a through T2e corresponding to the phonemes 34a through 34e included in the post-translation phoneme sequence 34 and utterance durations T3a and T3b corresponding to the phonemes 35a and 35b included in the post-translation phoneme sequence 35.

The pre-translation utterance duration determination part 25 may determine a duration of the same length as the utterance duration of each of the pre-translation phonemes included in the pre-translation phoneme sequence. Likewise, the post-translation utterance duration determination part 26 may determine a duration of the same length as the utterance duration of each of the post-translation phonemes included in the post-translation phoneme sequences.

In the example of FIG. 4, the pre-translation utterance duration determination part 25 determines the utterance durations T1a through T1c corresponding to the phonemes 33a through 33c by dividing a predetermined duration T by the number “3” of the phonemes 33a through 33c included in the pre-translation phoneme sequence 33. Here, the utterance durations T1a through T1c are each duration of the same length. Also in the example of FIG. 4, the post-translation utterance duration determination part 26 determines the utterance durations T2a through T2c of the same length corresponding to the phonemes 34a through 34e by dividing the predetermined duration T by the number “5” of the phonemes 34a through 34e included in the post-translation phoneme sequence 34, and determines the utterance durations T3a and T3b of the same length corresponding to the phonemes 35a and 35b by dividing the predetermined duration T by the number “2” of the phonemes 35a and 35b included in the post-translation phoneme sequence 35.

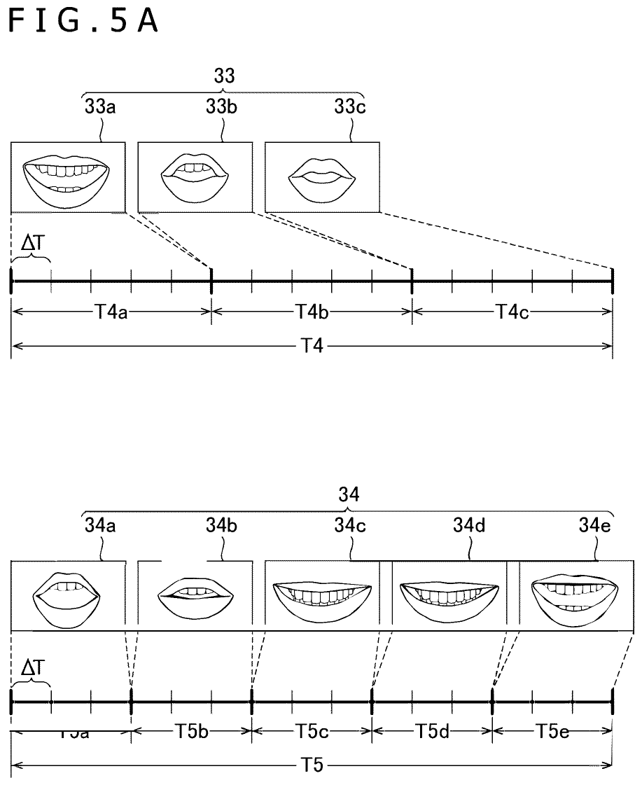

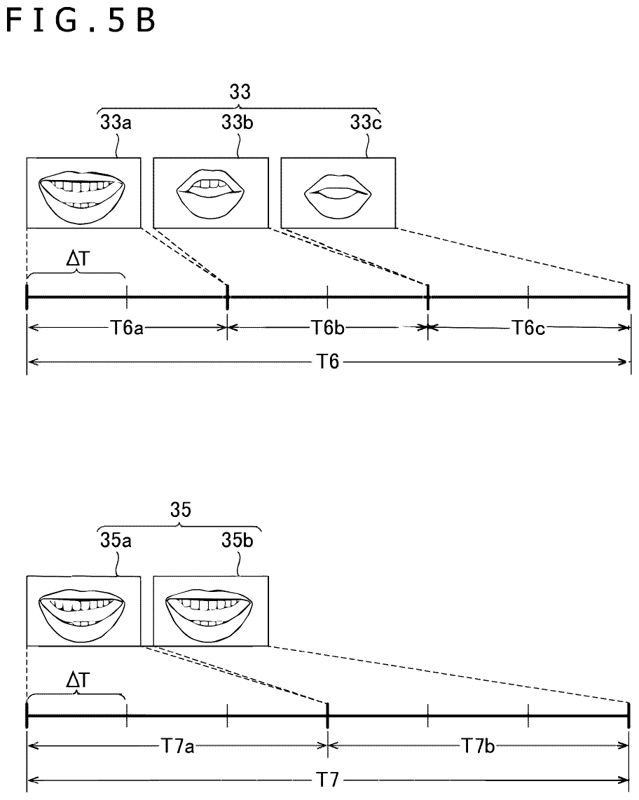

FIGS. 5A and 5B are each set of views depicting exemplary utterance durations of the phonemes included in the phoneme sequences. The pre-translation utterance duration determination part 25 may determine a duration of the same length corresponding to the number of the post-translation phonemes included in the post-translation phoneme sequence as the utterance duration of each of the pre-translation phonemes included in the pre-translation phoneme sequence. Likewise, the post-translation utterance duration determination part 26 may determine a duration of a length corresponding to the number of the pre-translation phonemes included in the pre-translation phoneme sequence as the utterance duration of each of the post-translation phonemes included in the post-translation phoneme sequences.

In the example of FIG. 5A, the pre-translation utterance duration determination part 25 determines utterance durations T4a through T4c of the same length corresponding to the phonemes 33a through 33c by multiplying a predetermined duration ΔT by the number “5” of the phonemes 34a through 34e included in the post-translation phoneme sequence 34. Also in the example of FIG. 5A, the post-translation utterance duration determination part 26 determines utterance durations T5a through T5e of the same length corresponding to the phonemes 34a through 34e by multiplying the predetermined duration ΔT by the number “3” of the phonemes 33a through 33c included in the pre-translation phoneme sequence 33. Here, a duration T4 connecting the utterance durations T4a through T4c continuously may coincide with a duration T5 connecting the utterance durations T5a through T5e continuously.

In the example of FIG. 5B, the pre-translation utterance duration determination part 25 determines utterance durations T6a through T6c of the same length corresponding to the phonemes 33a through 33c by multiplying the predetermined duration ΔT by the number “2” of the phonemes 35a and 35b included in the post-translation phoneme sequence 35. Also in the example of FIG. 5B, the post-translation utterance duration determination part 26 determines utterance durations T7a and T7b of the same length corresponding to the phonemes 35a and 35b by multiplying the predetermined duration ΔT by the number “3” of the phonemes 33a through 33c included in the pre-translation phoneme sequence 33. A duration T6 connecting the utterance durations T6a through T6c continuously may coincide with a duration T7 connecting the utterance durations T7a and T7b continuously.

### 1-2-4. Similarity Generation Part

The similarity generation part 27 generates a similarity degree indicating the similarity of the character's mouth movements, based on the mouth shape of the character corresponding to each pre-translation phenome included in the pre-translation phoneme sequence and on the mouth shape of the character corresponding to each post-translation phoneme included in the post-translation phoneme sequences. Doing this makes it possible to appropriately evaluate whether or not the translated text corresponds to the character's mouth movements.

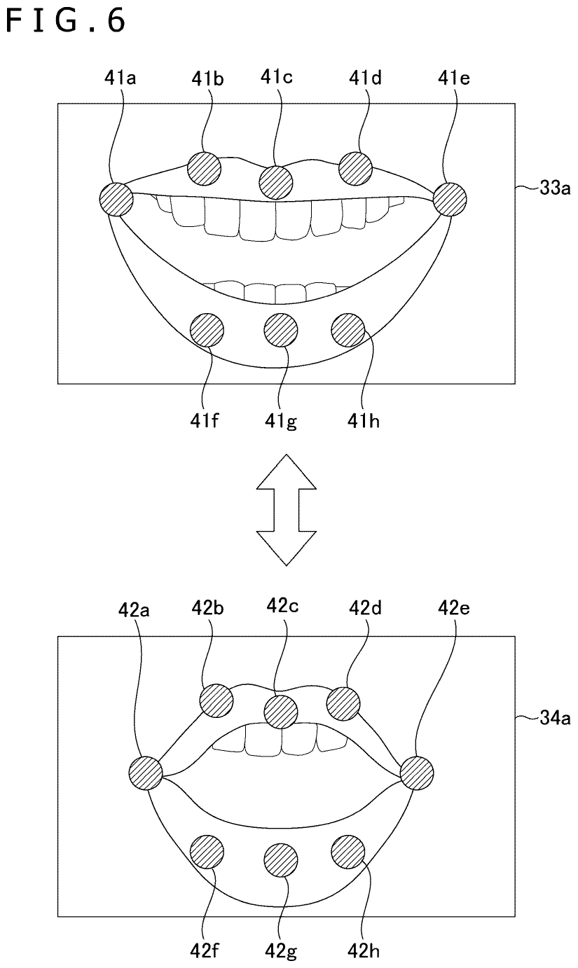

FIG. 6 is a set of views depicting an exemplary method of generating similarity degrees. In the example of FIG. 6, the similarity generation part 27 calculates a similarity of the character's mouth movements by comparing the positions of mouth feature points 41a through 41h corresponding to the phoneme 33a included in the pre-translation phoneme sequence 33 with the positions of mouth feature points 42 a through 42h corresponding to the phoneme 34a included in the post-translation phoneme sequence 34. For example, the similarity generation part 27 may calculate the similarity of the mouth shapes by calculating the distance between the feature point 41a and the feature point 42a. On the basis of the similarity of the mouth shapes thus calculated, the similarity generation part 27 may then generate a similarity degree indicating the similarity of the character's mouth movements indicated by the pre-and post-translation phoneme sequences.

Also, on the basis of the pre-and post-translation phonemes, the similarity generation part 27 may acquire the similarity of the character's mouth shapes stored in the storage part 12 or in an external storage device in association with these phonemes. Alternatively, the similarity generation part 27 may receive the similarity of the mouth shapes via the communication part 13.

As another alternative, the similarity generation part 27 may generate the similarity degree based on the character's mouth shape indicated by each of the pre-and post-translation phonemes of which the utterance durations overlap with each other.

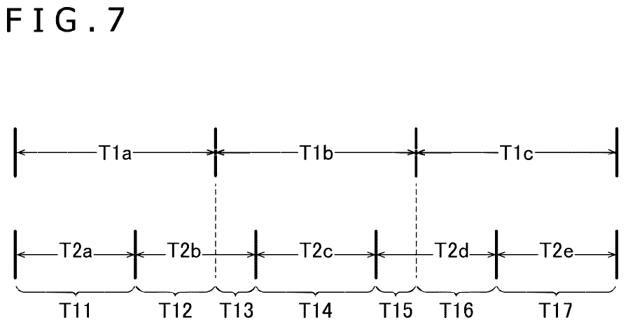

FIG. 7 is a view depicting durations in which the utterance durations in the example of FIG. 4 overlap with each other. In the examples of FIGS. 4 and 7, the similarity generation part 27 may calculate a similarity of the mouth shapes indicated by the phonemes 33a and 34a in a duration T11 where the utterance duration T1a of the pre-translation phoneme 33a and the utterance duration T2a of the post-translation phoneme 34a overlap with each other. Also, the similarity generation part 27 may calculate a similarity of the mouth shapes indicated by the phonemes 33a and 34b in a duration T12 where the utterance durations of the phoneme 33a and 34b overlap with each other; a similarity of the mouth shapes indicated by the phonemes 33b and 34b in a duration T13 where the utterance durations of the phoneme 33b and 34b overlap with each other; a similarity of the mouth shapes indicated by the phonemes 33b and 34c in a duration T14 where the utterance durations of the phoneme 33b and 34c overlap with each other; a similarity of the mouth shapes indicated by the phonemes 33b and 34d in a duration T15 where the utterance durations of the phoneme 33b and 34d overlap with each other; a similarity of the mouth shapes indicated by the phonemes 33c and 34d in a duration T16 where the utterance durations of the phonemes 33c and 34d overlap with each other; and a similarity of the mouth shapes indicated by the phonemes 33c and 34e in a duration T17 where the utterance durations of the phonemes 33c and 34e overlap with each other. The similarity generation part 27 may then multiply the values indicating multiple (seven, in the examples of FIGS. 4 and 7) similarity degrees calculated as described above, by each of the durations T11 through T17 so as to generate a similarity degree indicating the similarity of the character's mouth movements. Doing this makes it possible to appropriately evaluate whether or not the translated text corresponds to the character's mouth movements.

In the examples of FIGS. 5A and 5B, for each predetermined duration (e.g., duration ΔT in FIGS. 5A and 5B, or a duration shorter than the duration ΔT), the similarity generation part 27 may calculate a similarity between the mouth shape indicated by a pre-translation phoneme with its utterance overlapping with the predetermined duration (e.g., any one of the phonemes 33a through 33c in FIGS. 5A and 5B) on one hand and the mouth shape indicated by a post-translation phoneme with its utterance duration overlapping with the predetermined duration (e.g., any one of the phonemes 34a through 34e in FIG. 5A, or any one of the phonemes 35a and 35 in FIG. 5B) on the other hand. In this case, the similarity generation part 27 may generate a similarity degree indicating the similarity of the character's mouth movements, based on a cumulative total of the values indicating multiple similarities calculated for each of the predetermined durations. Doing this also makes it possible to appropriately evaluate whether or not the translated text corresponds to the character's mouth movements.

### 1-3. Flowchart

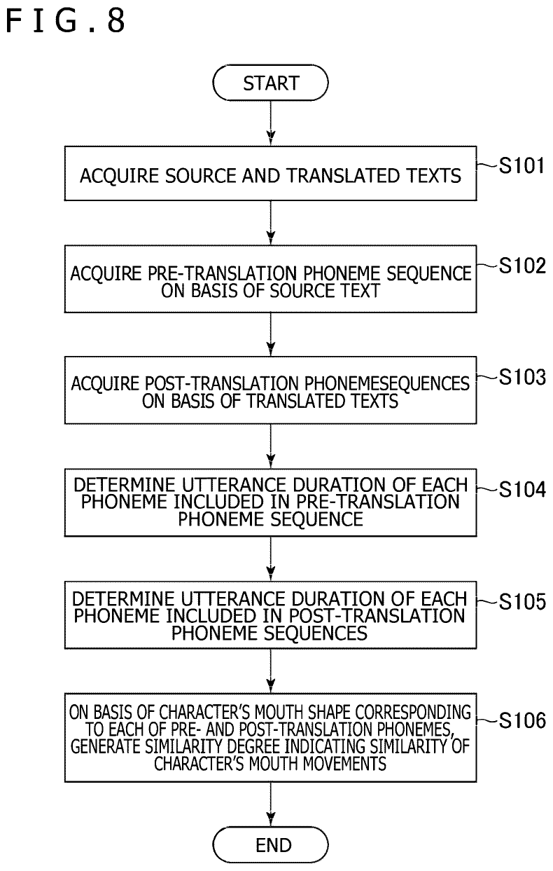

FIG. 8 is a flowchart depicting an exemplary flow of processing performed by the translation language evaluation apparatus 10 (translation language evaluation system). Explained below in reference to FIG. 8 is the flow of processing carried out by the translation language evaluation apparatus 10.

As indicated in FIG. 8, the source text acquisition part 21 acquires a pre-translation source text (e.g., source text 31 in English in FIG. 3), and the translated text acquisition part 22 acquires translated texts that are translations of the pre-translation source text into another language (e.g., translated texts 32a and 32b in Japanese in FIG. 3) (step S101).

On the basis of the source text acquired in step S101, the pre-translation phoneme sequence acquisition part 23 then acquires a pre-translation phoneme sequence indicating the order of the phonemes in that source text (step S102). Further, on the basis of the translated texts acquired in step S101, the post-translation phoneme sequence acquisition part 24 acquires post-translation phoneme sequences indicating the orders of the phonemes in the translated texts (step S103). It is to be noted that steps S102 and S103 may be performed in the reverse order.

In step S102, the pre-translation phoneme sequence acquisition part 23 may generate a pre-translation phoneme sequence with its phonemes (e.g., phonemes 33a through 33c in FIG. 3) on the basis of the source text acquired in step S101, or acquire the phoneme sequence stored in the storage part 12 or in an external storage device in association with the source text. Likewise, in step S103, the post-translation phoneme sequence acquisition part 24 may generate post-translation phoneme sequences with their phonemes (e.g., phonemes 34a through 34e, 35a, and 35b in FIG. 3) on the basis of the translated texts acquired in step S101, or acquire the phoneme sequences stored in the storage part 12 or in an external storage device in association with these translated texts.

Next, the pre-translation utterance duration determination part 25 determines an utterance duration of each of the phonemes included in the pre-translation phoneme sequence acquired in step S102 (step S104). Further, the post-translation utterance duration determination part 26 determines an utterance duration of each of the phonemes included in the post-translation phoneme sequences acquired in step S103 (step S105). It is to be noted that steps S104 and S105 may be carried out in the reverse order.

In step S104, the pre-translation utterance duration determination part 25 may determine a duration of the same length as the utterance duration of each of the phonemes included in the pre-translation phoneme sequence acquired in step S102. Likewise, in step S105, the post-translation utterance duration determination part 26 may determine a duration of the same length as the utterance duration of each of the phonemes included in the post-translation phoneme sequences acquired in step S103.

In step S104, as depicted in FIG. 4, the pre-translation utterance duration determination part 25 may determine the utterance duration corresponding to each of the pre-translation phonemes by dividing the predetermined duration T by the number of the phonemes included in the pre-translation phoneme sequence (e.g., phonemes 33a through 33c included in the phoneme sequence 33 in FIG. 4) acquired in step S102. Likewise, in step S105, the post-translation utterance duration determination part 26 may determine the utterance duration corresponding to each of the post-translation phonemes by dividing the predetermined duration T by the number of the phonemes included in the post-translation phoneme sequence (e.g., phonemes 34a through 34e included in the phoneme sequence 34 in FIG. 4) acquired in step S103.

In step S104, as indicated in FIGS. 5A and 5B, the pre-translation utterance duration determination part 25 may determine the utterance duration corresponding to each of the phonemes included in the pre-translation phoneme sequence acquired in step S102 by multiplying the predetermined duration ΔT by the number of the phonemes included in the post-translation phoneme sequence (e.g., phonemes 34a through 34e included in the phoneme sequence 34 in FIG. 5A) acquired in step S103. Likewise, in step S105, the post-translation utterance duration determination part 26 may determine the utterance duration corresponding to each of the phonemes included in the post-translation phoneme sequences by multiplying the predetermined duration ΔT by the number of the phonemes included in the pre-translation phoneme sequence (e.g., phonemes 33a through 33c included in the phoneme sequence 33 in FIG. 5A).

Next, the similarity generation part 27 generates a similarity degree indicating the similarity of the character's mouth movements on the basis of the character's mouth shape corresponding to each of the pre-and post-translation phonemes (step S106). The translation language evaluation apparatus 10 then terminates its processing.

In step S106, for example, the similarity generation part 27 may calculate the similarity of the character's mouth shapes by comparing the positions of the mouth feature points 41a through 41h corresponding to the phoneme 33a included in the pre-translation phoneme sequence 33 acquired in step S102, with the positions of the mouth feature points 42a through 42h corresponding to the phoneme 34a included in the post-translation phoneme sequence 34 acquired in step S103. On the basis of the similarity of the mouth shapes thus calculated, the similarity generation part 27 may generate the similarity degree indicating the similarity of the character's mouth movements indicated by the pre-and post-translation phoneme sequences.

In step S106, based on the phonemes included in the pre-translation phoneme sequence acquired in step S102 and on the phonemes included in the post-translation phoneme sequence acquired in step S103, the similarity generation part 27 may alternatively acquire the similarity of the character's mouth movements stored in the storage part 12 or in an external storage device in association with these phonemes.

In step S106, based on the character's mouth shapes indicated by the pre-and post-translation phonemes of which the utterance durations overlap with each other, the similarity generation part 27 may alternatively generate the similarity degree indicating the similarity of the character's mouth movements. In step S106, on the basis of the similarity of the mouth shape calculated for each of the durations T11 through T17 where the pre-and post-translation phonemes indicated in FIG. 7 overlap with one another, for example, the similarity generation part 27 may alternatively generate the similarity degree indicating the similarity of the character's mouth movements. In this case, the similarity degree indicating the similarity of the character's mouth movements may be generated by multiplying each of the durations T11 through T17 by a value indicating the similarity of the mouth shapes indicated by the pre-and post-translation phonemes in each of these durations.

Further, in step S106, for each predetermined duration (e.g., duration ΔT in FIGS. 5A and 5B, or a duration shorter than the duration ΔT), for example, the similarity generation part 27 may calculate a value indicating the similarity of the mouth shapes indicated by the pre- and post-translation phonemes of which the utterance durations overlap with that predetermined duration and, based on a cumulative total of the values thus calculated, may generate a similarity degree indicating the similarity of the character's mouth movements.

As described above, the similarity generation part 27 generates a similarity degree indicating the similarity of the character's mouth movements, based on the character's mouth shape corresponding to each of the pre-translation phonemes included in the pre-translation phoneme sequence and on the character's mouth shape corresponding to each of the post-translation phonemes included in the post-translation phoneme sequence. Doing this makes it possible to appropriately evaluate whether or not the translated text corresponds to the character's mouth movements.

Further, in this implementation, the pre-translation utterance duration determination part 25 determines a duration of the same length as the utterance duration of each phoneme included in the pre-translation phoneme sequence. Likewise, the post-translation utterance duration determination part 26 determines a duration of the same length as the utterance duration of each phoneme included in the post-translation phoneme sequence. The similarity generation part 27 then generates the similarity based on the character's mouth shapes indicated by the pre- and post-translation phonemes of which the utterance durations overlap with each other. Doing this makes it possible to appropriately evaluate whether or not the translated text corresponds to the character's mouth movements.

The present disclosure is not limited to the implementation discussed above when practiced. For example, alternative examples derived from the above implementation can also fall within the technical scope of this disclosure.

### 2. Second Implementation

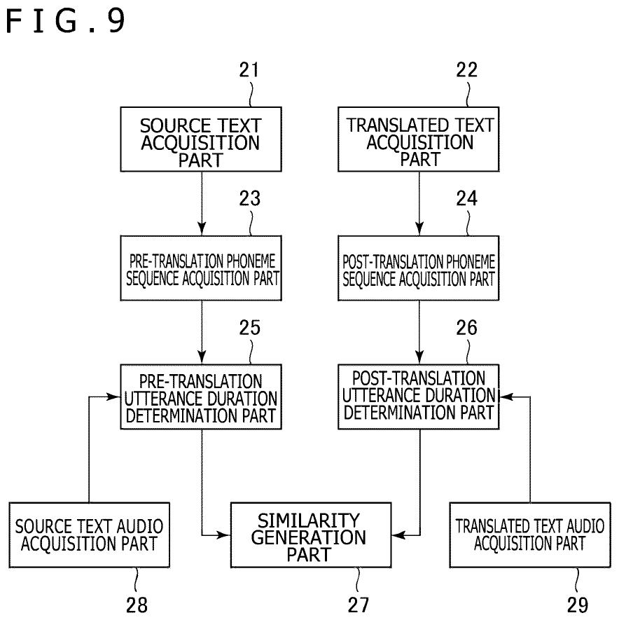

FIG. 9 is a functional block diagram depicting other exemplary functions implemented by the translation language evaluation apparatus 10 (translation language evaluation system). In addition to the functions explained above in connection with the first implementation, the translation language evaluation apparatus 10 may include a source text audio acquisition part 28 and a translated text audio acquisition part 29 indicated in FIG. 9. The source text audio acquisition part 28 and the translated text audio acquisition part 29 may be implemented mainly by the processor 11.

The source text audio acquisition part 28 acquires the audio of the source text obtained by the source text acquisition part 21. For example, the source text audio acquisition part 28 acquires the audio of the source text 31 in English indicated in FIG. 3. Further, the translated text audio acquisition part 29 acquires the audio of the translated texts obtained by the translated text acquisition part 22. For example, the translated text audio acquisition part 29 acquires the audio of the translated texts 32a and 32b in Japanese indicated in FIG. 3.

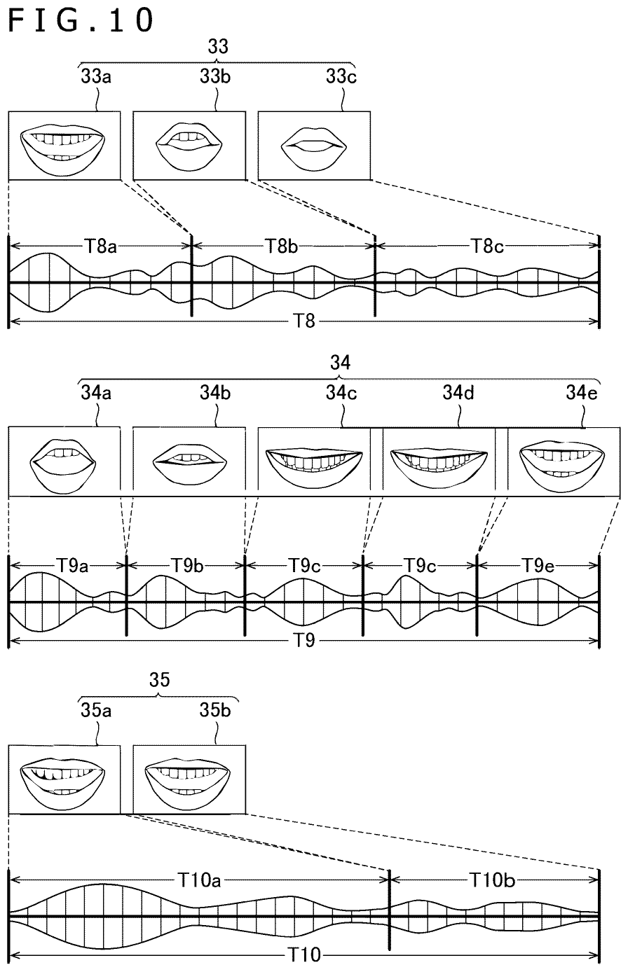

FIG. 10 is a set of views depicting exemplary utterance durations of the phonemes included in the phoneme sequences. As depicted in FIG. 10, on the basis of the audio of the source text 31 (see FIG. 3) acquired by the source text audio acquisition part 28, the pre-translation utterance duration determination part 25 may determine utterance durations T8a through T8c of the phonemes 33a through 33c included in the pre-translation phoneme sequence 33 acquired by the pre-translation phoneme sequence acquisition part 23. The pre-translation utterance duration determination part 25 may also determine utterance durations T9a through T9e of the phonemes 34a through 34e included in the post-translation phoneme sequence 34 acquired by the post-translation phoneme sequence acquisition part 24, on the basis of the audio of the translated text 32a (see FIG. 3) obtained by the translated text audio acquisition part 29. Likewise, the pre-translation utterance duration determination part 25 may determine utterance durations T10a and T10b of the phonemes 35a and 35b included in the post-translation phoneme sequence 35 on the basis of the audio of the translated text 32b (see FIG. 3).

The pre-translation utterance duration determination part 25 and the post-translation utterance duration determination part 26 may determine the utterance duration of each of the phonemes included in the phoneme sequences by analyzing the audio. For example, the post-translation utterance duration determination part 26 may edit the audio of the translated text 32a in a manner allowing the utterance duration T9 in the audio of the translated text 32a to coincide with the utterance duration T8 in the audio of the source text 31 and, based on the audio thus edited, may determine the utterance durations T9a through T9e of the phonemes 34a through 34e included in the post-translation phoneme sequence 34. Alternatively, the pre-translation utterance duration determination part 25 may edit the audio of the source text 31 in a manner allowing the utterance duration T9 in the audio of the source text 31 to coincide with the utterance duration T8 in the audio of the translated text 32a and, based on the audio thus edited, may determine the utterance durations T8a through T8c of the phonemes 33a through 33c included in the pre-translation phoneme sequence 33.

In this implementation, the similarity generation part 27 may also generate a similarity degree indicating the similarity of the character's mouth movements, based on the character's mouth shapes indicated by the pre-and post-translation phonemes of which the utterance durations overlap with each other. The similarity generation part 27 may further generate a similarity degree indicating the similarity of the character's mouth movements by multiplying a duration in which the pre-and post-translation phonemes overlap with each by a value indicating the similarity of the mouth shapes indicated by these pre-and post-translation phonemes in that duration. Also, for each predetermined duration (e.g., duration ΔT in FIGS. 5A and 5B, or a duration shorter than the duration ΔT), the similarity generation part 27 may calculate a value indicating the similarity of the mouth shapes indicated by the pre-and post-translation phonemes of which the utterance durations overlap with the predetermined duration and, based on a cumulative total of the values thus calculated, may generate a similarity degree indicating the similarity of the character's mouth movements. Doing this makes it possible to evaluate more appropriately whether or not the translated text corresponds to the character's mouth movements.

For example, in a case where the utterance duration T10 in the audio of the translated text 32b is shorter than the utterance duration T8 in the audio of the source text 31, the post-translation utterance duration determination part 26 may also determine the duration from the point in time at which the utterance duration T10 ends until the point in time at which the utterance duration T8 ends as the duration of a predetermined post-translation phoneme (e.g., phoneme indicating that the character's mouth is closed). In this case, the similarity generation part 27 may generate a similarity degree indicating the similarity of the character's mouth movements on the basis of the character's mouth shapes indicated both by a pre-translation phoneme in the duration from the point in time at which the utterance duration T10 ends until the point in time at which the utterance duration T8 ends (e.g., phoneme 33c in FIG. 10) and by a predetermined post-translation phoneme in that duration. Doing this also makes it possible to evaluate more appropriately whether or not the translated text corresponds to the character's mouth movements.

### 3. CONCLUSION

(1) The translation language evaluation apparatus 10 described above in the present disclosure may include at least one processor (e.g., processor 11). The at least one processor may acquire a pre-translation phoneme sequence (e.g., phoneme sequence 33 in FIG. 3) indicating an order of pre-translation phonemes on the basis of a pre-translation source text (e.g., source text 31 in FIG. 3). On the basis of translated texts (e.g., translated texts 32a and 32b) that are translations of a language of the pre-translation source text into another language, the at least one processor may acquire post-translation phoneme sequences (e.g., phoneme sequences 34 and 35 in FIG. 3) indicating the orders of post-translation phonemes. On the basis of a character's mouth shape corresponding to each of the pre-translation phonemes included in the pre-translation phoneme sequence and the character's mouth shape corresponding to each of the post-translation phonemes included in the post-translation phoneme sequences, the at least one processor may generate a similarity degree indicating a similarity of the character's mouth movements. Doing this makes it possible to appropriately evaluate whether or not the translated text corresponds to the character's mouth movements.
(6) Further, the translation language evaluation system described above in the present disclosure may include at least one processor (e.g., processor 11). The at least one processor may acquire a pre-translation phoneme sequence (e.g., phoneme sequence 33 in FIG. 3) indicating the order of pre-translation phonemes on the basis of a pre-translation source text (e.g., source text 31 in FIG. 3). On the basis of translated texts (e.g., translated texts 32a and 32b) that are translations of a language of the pre-translation source text into another language, the at least one processor may acquire post-translation phoneme sequences (e.g., phoneme sequences 34 and 35 in FIG. 3) indicating the orders of post-translation phonemes. On the basis of a character's mouth shape corresponding to each of the pre-translation phonemes included in the pre-translation phoneme sequence and the character's mouth shape corresponding to each of the post-translation phonemes included in the post-translation phoneme sequences, the at least one processor may generate a similarity degree indicating a similarity of the character's mouth movements. Doing this makes it possible to appropriately evaluate whether or not the translated text corresponds to the character's mouth movements.
(7) Further, the translation language evaluation method described above in the present disclosure may include a step of acquiring a pre-translation phoneme sequence (e.g., phoneme sequence 33 in FIG. 3) indicating an order of pre-translation phonemes on the basis of a pre-translation source text (e.g., source text 31 in FIG. 3), on the basis of translated texts (e.g., translated texts 32a and 32b) that are translations of a language of the pre-translation source text into another language, a step of acquiring post-translation phoneme sequences (e.g., phoneme sequences 34 and 35 in FIG. 3) indicating the orders of post-translation phonemes, and, on the basis of a character's mouth shape corresponding to each of the pre-translation phonemes included in the pre-translation phoneme sequence and the character's mouth shape corresponding to each of the post-translation phonemes included in the post-translation phoneme sequences, a step of generating a similarity degree indicating a similarity of the character's mouth movements. Doing this makes it possible to appropriately evaluate whether or not the translated text corresponds to the character's mouth movements.
(8) Further, the program described above in the present disclosure may cause the translation language evaluation apparatus 10 that is a computer to perform a procedure of acquiring a pre-translation phoneme sequence (e.g., phoneme sequence 33 in FIG. 3) indicating an order of pre-translation phonemes on the basis of a pre-translation source text (e.g., source text 31 in FIG. 3), on the basis of translated texts (e.g., translated texts 32a and 32b in FIG. 3) that are translations of a language of the pre-translation source text into another language, a procedure of acquiring post-translation phoneme sequences (e.g., phoneme sequences 34 and 35 in FIG. 3) indicating the orders of post-translation phonemes, and, on the basis of a character's mouth shape corresponding to each of the pre-translation phonemes included in the pre-translation phoneme sequence and the character's mouth shape corresponding to each of the post-translation phonemes included in the post-translation phoneme sequences, a procedure of generating a similarity degree indicating a similarity of the character's mouth movements. Doing this makes it possible to appropriately evaluate whether or not the translated text corresponds to the character's mouth movements.
(2) In the translation language evaluation apparatus 10 described in paragraph (1) above, the at least one processor may determine an utterance duration of each of the pre-translation phonemes (e.g., durations T1a through T1c in FIG. 4, durations T4a through T4c in FIG. 5A, durations T6a through T6c in FIG. 5B, and durations T8a through T8c in FIG. 10) included in the pre-translation phoneme sequence. The at least one processor may determine an utterance duration of each of the post-translation phonemes (e.g., durations T2a through T2e, T3a, and T3b in FIG. 4, durations T4a through T4e in FIG. 5A, durations T7a and T7b in FIG. 5B, and durations T9a through T9e, T10a, and T10b in FIG. 10) included in the post-translation phoneme sequences. The at least one processor may then generate the similarity based on the mouth shape of the character indicated by each of the pre-and post-translation phonemes of which the utterance durations overlap with each other.
(3) In the translation language evaluation apparatus 10 described in paragraph (2) above, the at least one processor may determine a duration of the same length as the utterance duration of each of the pre-translation phonemes (e.g., durations T1a through T1c in FIG. 4, durations T4a through T4c in FIG. 5A, and durations T6a through T6c in FIG. 5B) included in the pre-translation phoneme sequence. The at least one processor may further determine a duration of the same length as the utterance duration of each of the post-translation phonemes (e.g., durations T2a through T2e, T3a, and T3b in FIG. 4, durations T4a through T4e in FIG. 5A, and durations T7a and T7b in FIG. 5B) included in the post-translation phoneme sequences.
(4) In the translation language evaluation apparatus 10 described in paragraph (3) above, the at least one processor may determine, as the utterance duration of each of the pre-translation phonemes included in the pre-translation phoneme sequence, a duration corresponding to the number of the post-translation phonemes (e.g., durations T4a through T4c in FIG. 5A, and durations T6a through T6c in FIG. 5B) included in the post-translation phoneme sequences. The at least one processor may further determine, as the utterance duration of each of the post-translation phonemes included in the post-translation phoneme sequences, a duration corresponding to the number of the pre-translation phonemes (e.g., durations T4a through T4e in FIG. 5A, and durations T7a and T7b in FIG. 5B) included in the pre-translation phoneme sequence.
(5) In the translation language evaluation apparatus 10 described in paragraph (2) above, the at least one processor may acquire the audio of the source text. The at least one processor may acquire the audio of the translated texts. On the basis of the audio of the source text, the at least one processor may determine the utterance duration of each of the pre-translation phonemes (e.g., durations T8a through T8c in FIG. 10) included in the pre-translation phoneme sequence. On the basis of the audio of the translated texts, the at least one processor may further determine the utterance duration of each of the post-translation phonemes (e.g., durations T9a through T9e, T10a, and T10b in FIG. 10) included in the post-translation phoneme sequences.

What is claimed is:

1. A translation language evaluation apparatus comprising:
one or more computer processors; and
one or more non-transitory computer-readable media that store instructions which, when executed by the one or more computer processors, cause the one or more computer processors to perform operations comprising:
obtaining a pre-translation phoneme sequence indicating an order of pre-translation phonemes based at least on a pre-translation source text,
based at least on a translated text that is a translation of a language of the pre-translation source text into another language, obtaining a post-translation phoneme sequence indicating an order of post-translation phonemes, and
based at least on a mouth shape of a character corresponding to each of the pre-translation phonemes included in the pre-translation phoneme sequence and a mouth shape of the character corresponding to each of the post-translation phonemes included in the post-translation phoneme sequence, generating a similarity degree indicating a similarity of mouth movements of the character.

2. The translation language evaluation of claim 1, wherein the operations comprise:
determining an utterance duration of each of the pre-translation phonemes included in the pre-translation phoneme sequence,
determining an utterance duration of each of the post-translation phonemes included in the post-translation phoneme sequence, and
generating the similarity based on the mouth shape of the character indicated by each of the pre-and post-translation phonemes of which the utterance durations overlap with each other.

3. The translation language evaluation of claim 2, wherein the operations comprise:
determining a duration of a same length as the utterance duration of each of the pre-translation phonemes included in the pre-translation phoneme sequence, and
determining a duration of the same length as the utterance duration of each of the post-translation phonemes included in the post-translation phoneme sequence.

4. The translation language evaluation apparatus of claim 3, wherein the operations comprise:
determining, as the utterance duration of each of the pre-translation phonemes included in the pre-translation phoneme sequence, a duration corresponding to the number of the post-translation phonemes included in the post-translation phoneme sequence, and
determining, as the utterance duration of each of the post-translation phonemes included in the post-translation phoneme sequence, a duration corresponding to the number of the pre-translation phonemes included in the pre-translation phoneme sequence.

5. The translation language evaluation apparatus of claim 2, wherein the operations comprise:
obtaining audio of the source text,
obtaining the audio of the translated text,
based at least on the audio of the source text, determining the utterance duration of each of the pre-translation phonemes included in the pre-translation phoneme sequence, and
based at least on the audio of the translated text, determining the utterance duration of each of the post-translation phonemes included in the post-translation phoneme sequence.

6. The translation language evaluation apparatus of claim 1, wherein the operations comprise determining a mouth shape of the character corresponding to each of the pre-translation phonemes in the pre-translation phoneme sequence.

7. The translation language evaluation apparatus of claim 1, wherein the operations comprise determining a mouth shape of the character corresponding to each of the post-translation phonemes in the post-translation phoneme sequence.

8. One or more non-transitory computer-readable media that store instructions which, when executed by one or more computer processors, cause the one or more computer processors to perform operations comprising:
obtaining a pre-translation phoneme sequence indicating an order of pre-translation phonemes based at least on a pre-translation source text,
based at least on a translated text that is a translation of a language of the pre-translation source text into another language, obtaining a post-translation phoneme sequence indicating an order of post-translation phonemes, and
based at least on a mouth shape of a character corresponding to each of the pre-translation phonemes included in the pre-translation phoneme sequence and a mouth shape of the character corresponding to each of the post-translation phonemes included in the post-translation phoneme sequence, generating a similarity degree indicating a similarity of mouth movements of the character.

9. The media of claim 8, wherein the operations comprise:
determining an utterance duration of each of the pre-translation phonemes included in the pre-translation phoneme sequence,
determining an utterance duration of each of the post-translation phonemes included in the post-translation phoneme sequence, and
generating the similarity based on the mouth shape of the character indicated by each of the pre-and post-translation phonemes of which the utterance durations overlap with each other.

10. The media of claim 8, wherein the operations comprise:
determining a duration of a same length as the utterance duration of each of the pre-translation phonemes included in the pre-translation phoneme sequence, and
determining a duration of the same length as the utterance duration of each of the post-translation phonemes included in the post-translation phoneme sequence.

11. The media of claim 10, wherein the operations comprise:
determining, as the utterance duration of each of the pre-translation phonemes included in the pre-translation phoneme sequence, a duration corresponding to the number of the post-translation phonemes included in the post-translation phoneme sequence, and
determining, as the utterance duration of each of the post-translation phonemes included in the post-translation phoneme sequence, a duration corresponding to the number of the pre-translation phonemes included in the pre-translation phoneme sequence.

12. The media of claim 9, wherein the operations comprise:
obtaining audio of the source text,
obtaining the audio of the translated text,
based at least on the audio of the source text, determining the utterance duration of each of the pre-translation phonemes included in the pre-translation phoneme sequence, and
based at least on the audio of the translated text, determining the utterance duration of each of the post-translation phonemes included in the post-translation phoneme sequence.

13. The media of claim 8, wherein the operations comprise determining a mouth shape of the character corresponding to each of the pre-translation phonemes in the pre-translation phoneme sequence.

14. The media of claim 8, wherein the operations comprise determining a mouth shape of the character corresponding to each of the post-translation phonemes in the post-translation phoneme sequence.

15. A computer-implemented method comprising:
obtaining a pre-translation phoneme sequence indicating an order of pre-translation phonemes based at least on a pre-translation source text,
based at least on a translated text that is a translation of a language of the pre-translation source text into another language, obtaining a post-translation phoneme sequence indicating an order of post-translation phonemes, and
based at least on a mouth shape of a character corresponding to each of the pre-translation phonemes included in the pre-translation phoneme sequence and a mouth shape of the character corresponding to each of the post-translation phonemes included in the post-translation phoneme sequence, generating a similarity degree indicating a similarity of mouth movements of the character.

16. The method of claim 15, comprising:
determining an utterance duration of each of the pre-translation phonemes included in the pre-translation phoneme sequence,
determining an utterance duration of each of the post-translation phonemes included in the post-translation phoneme sequence, and
generating the similarity based on the mouth shape of the character indicated by each of the pre-and post-translation phonemes of which the utterance durations overlap with each other.

17. The method of claim 15, comprising:
determining a duration of a same length as the utterance duration of each of the pre-translation phonemes included in the pre-translation phoneme sequence, and
determining a duration of the same length as the utterance duration of each of the post-translation phonemes included in the post-translation phoneme sequence.

18. The method of claim 17, comprising:
determining, as the utterance duration of each of the pre-translation phonemes included in the pre-translation phoneme sequence, a duration corresponding to the number of the post-translation phonemes included in the post-translation phoneme sequence, and
determining, as the utterance duration of each of the post-translation phonemes included in the post-translation phoneme sequence, a duration corresponding to the number of the pre-translation phonemes included in the pre-translation phoneme sequence.

19. The method of claim 16, comprising:
obtaining audio of the source text,
obtaining the audio of the translated text,
based at least on the audio of the source text, determining the utterance duration of each of the pre-translation phonemes included in the pre-translation phoneme sequence, and
based at least on the audio of the translated text, determining the utterance duration of each of the post-translation phonemes included in the post-translation phoneme sequence.

20. The method of claim 15, comprising determining a mouth shape of the character corresponding to each of the pre-translation phonemes in the pre-translation phoneme sequence.
